(19) United States
(12) Patent Application Publication
(10) Pub. No.: US 2019/0005595 A1
(43) Pub. Date: Jan. 3, 2019

(54) System and Method of Peer-to-Peer Electronic Exchange of Intellectual Property

(71) Applicant: Kyle Tautenhan, (US)

(72) Inventors: Kyle Tautenhan, Omaha, NE (US); De'Ontarius Ramone Summers, Nashville, TN (US)

(21) Appl. No.: 16/107,784

(22) Filed: Aug. 21, 2018

Related U.S. Application Data
(60) Provisional application No. 62/548,160, filed on Aug. 21, 2017.

(51) Int. Cl. G06Q 50/18; H04L 9/32; G06Q 30/08

(52) U.S. Cl. CPC G06Q 50/184; H04L 9/3226; H04L 2209/38; H04L 2209/56; G06Q 30/08

(57) ABSTRACT

A system includes a cryptographic blockchain network (CBN) including a set of processing nodes. The processing nodes each include one or more processors configured to: receive identification information from one or more sellers associated with intellectual property (IP), receive identification information associated with the one or more sellers, verify the identification information associated with the IP and the identification information associated with the one or more sellers by referencing an intellectual property database, and convert the IP into a Smart IP Contract, wherein the Smart IP Contract performs one or more functions to carry out a sale of the IP on the CBN.

### CROSS-REFERENCE TO RELATED APPLICATION

The present application claims the benefit under 35 U.S.C. § 119(e) of U.S. Provisional Patent Application Ser. No. 62/548,160, filed Aug. 21, 2017, titled SYSTEM AND METHOD OF PEER-TO-PEER ELECTRONIC EXCHANGE OF INTELLECTUAL PROPERTY, naming Kyle Tautenhan and De′Ontarius Ramone Summers as inventors, which is incorporated herein by reference in the entirety.

### TECHNICAL FIELD

The present invention generally relates to electronic transactions, and, more particularly, to peer-to-peer electronic exchange of intellectual property ownership.

### INTRODUCTION

Intellectual property is often one of the most valuable assets a company possesses. While companies and inventors often develop intellectual property (IP) for their own use and protection, a substantial portion of trademarks, copyrights, and patents are developed with the intention of marketing and selling the IP. Furthermore, many companies actively search for patents and other IP in order to create a robust IP portfolio. However, despite the existence of potential buyers and potential sellers, there is no current system to streamline IP transactions. Currently, IP sellers have to actively search for buyers, and vice versa, leading to an inefficient marketplace. As such, a large portion of IP on the market for sale is never discovered, and remains under-utilized. Therefore, it would be desirable to provide a method and system that cure the shortfalls of the previous approaches identified above.

### BRIEF DESCRIPTION OF THE DRAWINGS

The numerous advantages of the disclosure may be better understood by those skilled in the art by reference to the accompanying figures in which:

FIG. 1 illustrates a flowchart of a method for electronically exchanging intellectual property, in accordance with one or more embodiments of the present disclosure.

FIG. 2 illustrates a simplified block diagram of a blockchain network with an intellectual property database, in accordance with one or more embodiments of the present disclosure.

FIG. 3 illustrates a simplified block diagram of an intellectual property smart contract, in accordance with one or more embodiments of the present disclosure.

FIG. 4 illustrates a simplified block diagram of an intellectual property smart contract library, in accordance with one or more embodiments of the present disclosure.

FIG. 5 illustrates a flowchart of a method for peer-to-peer electronic exchange of intellectual property ownership, in accordance with one or more embodiments of the present disclosure.

### DETAILED DESCRIPTION

Reference will now be made in detail to the subject matter disclosed, which is illustrated in the accompanying drawings.

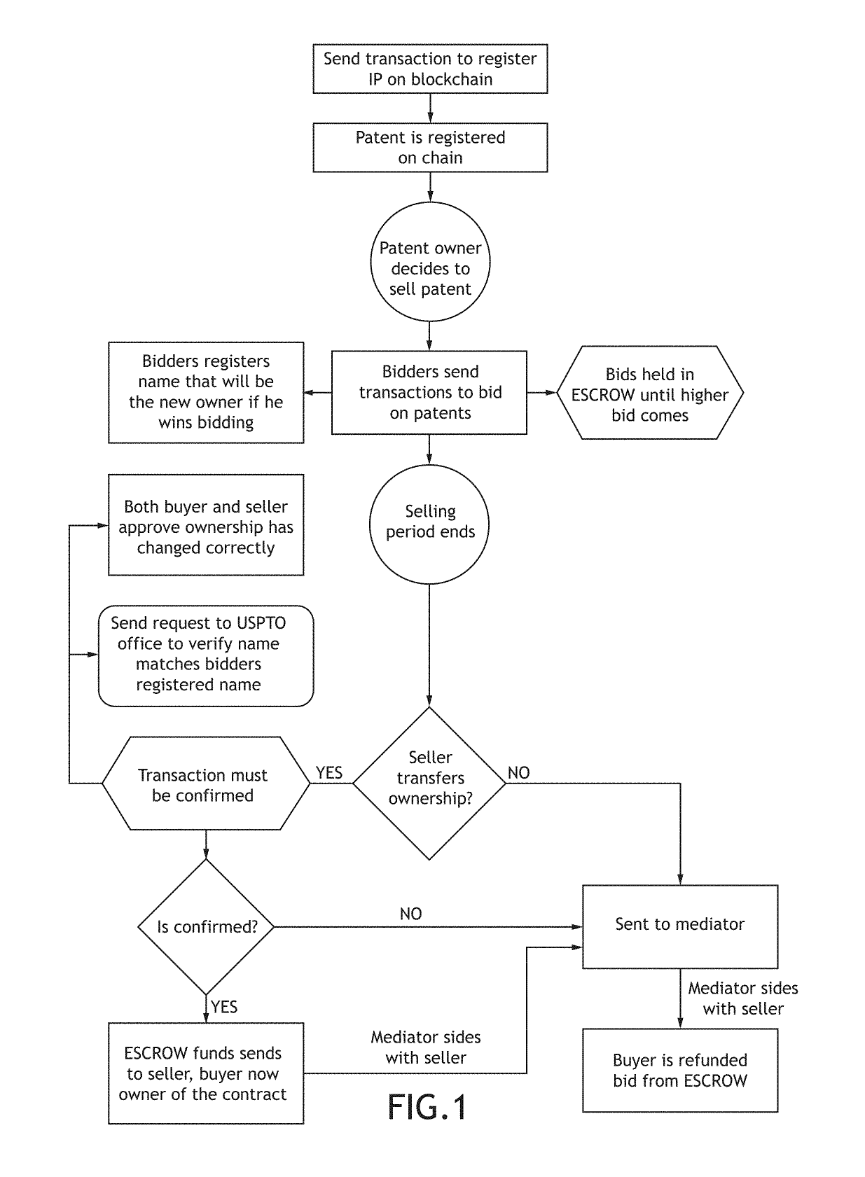

Referring generally to FIGS. 1 through 5, a system and method for peer-to-peer electronic exchange of intellectual property ownership is illustrated, in accordance with one or more embodiments of the present disclosure.

Unlike buying and selling tangible goods and services, there is currently no system or method for effectively buying and selling intellectual property (IP) (e.g., patents, copyrights, and trademarks). Companies and individuals who wish to sell their IP typically must actively search for buyers. Similarly, companies that wish to develop a diverse IP portfolio typically must actively search and solicit inventors. This creates an extremely inefficient marketplace.

Embodiments of the present disclosure are directed to methods and systems for exchanging intellectual property electronically. In one embodiment, the present disclosure is directed to using a blockchain or distributed leger (e.g., Ethereum) in order to facilitate the marketing and sale of IP. In another embodiment, the present disclosure is directed to the use of smart contracts to further facilitate the marketing and sale of IP. In this regard, some embodiments of the present disclosure are directed toward simplifying and automating IP sale transactions between buyers and sellers.

FIG. 1 illustrates a flowchart of a method for electronically exchanging intellectual property, in accordance with one or more embodiments of the present disclosure.

As depicted in FIG. 1, the method of the present disclosure may include registering IP on the blockchain, receiving bids from potential buyers (e.g., “bidders”), holding bid funds in escrow, transferring ownership of the IP, and confirming the transaction. The present disclosure may also include sending the transaction to a mediator.

It is noted that FIG. 1 refers specifically to buying and selling patents for the sake of simplicity. It is further noted that this is not to be regarded as a limitation of the present disclosure. In this regard, it is to be understood that both the foregoing description and the following detailed description may include, but is not limited to, the sale of patents, trademarks, copyright, and the like. In this regard, the term “patent” as it is used in FIG. 1 may be considered to refer to “intellectual property (IP)” generally.

In one embodiment, as depicted in FIG. 1, a seller may submit their IP (e.g., patents, trademarks, and copyrights) such that the IP may be registered on the blockchain. Registering IP on the blockchian may be required such that the IP may be properly indexed, searched, and identified by potential buyers. Furthermore, registering IP on the blockchain may include inputting identifying information regarding both the seller and the IP to be sold.

In another embodiment, registering the IP on the blockchain may include verifying the identity of the seller and verifying the characteristics of the IP to be sold. In one embodiment, in order for the IP to be verified and registered on the blockchain, a user may input IP identification information via a user interface of a processing node of a cryptographic blockchain network (CBN). It is noted that IP identification information may include any identifying characteristics known in the art. For example, IP identification fields relating to a patent may include, but are not limited to, application number, patent number, publication number, international registration number, Patent Cooperation Treaty (PCT) number, reel/frame number, inventor, assignee, seller, and the like. By way of another example, IP identification fields relating to a trademark may include, but are not limited to, reel/frame number, serial number, registration number, international registration number, applicant, assignee, seller, and the like.

In another embodiment, a user (e.g., seller) may submit user-entered IP identification via a user interface of a decentralized processing node of a CBN in order for the patent to be verified and registered. In another embodiment, the processing node may be connected to the CBN via an externally owned account (e.g., MetaMask).

In one embodiment, both sellers and the relevant IP may be verified through an identify management system and/or by reference to an intellectual property database (e.g., IP database). In this regard, verifying IP may include verifying the IP to be placed on the market is what it is purported to be, and that the seller has the right to convey title. Furthermore, verification may include determining the existence of any assignees or recorded licenses. In one embodiment, verifying the IP to be sold includes cross-checking the entered IP identification information with data kept by the United States Patent and Trademark Office (USPTO).

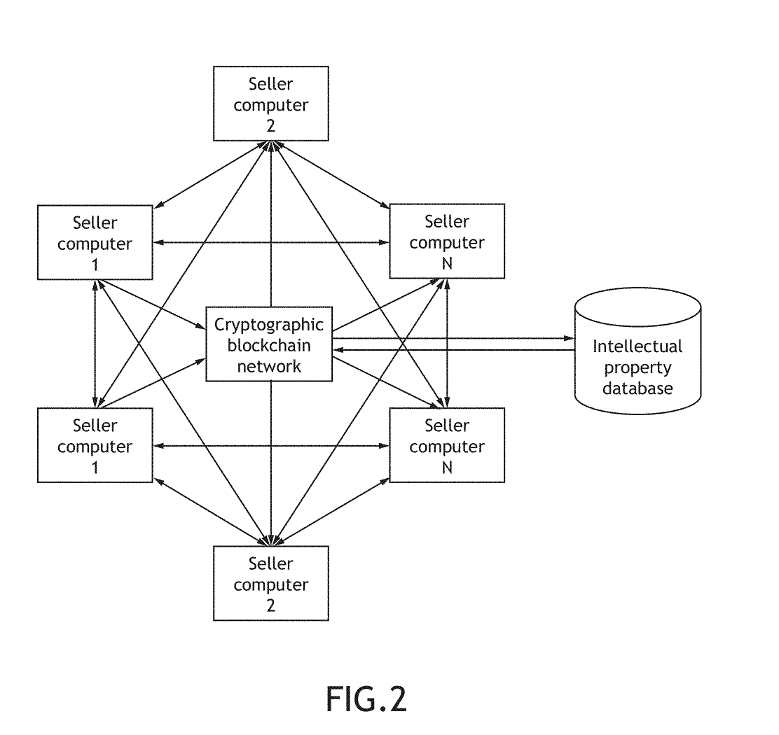

FIG. 2 illustrates a simplified block diagram of a blockchain network with an intellectual property database, in accordance with one or more embodiments of the present disclosure.

In one embodiment, the CBN may include a distributed peer-to-peer network of interconnected processing nodes (e.g., Buyer Computer 1, Seller Computer 2, and the like). In one embodiment, the present disclosure may require sellers and IP to be verified in order to be registered on the CBN. In one embodiment, as stated previously, sellers and IP may be verified through an identity management system. In another embodiment, sellers and IP may be verified by reference to an intellectual property database (“IP database”), as shown in FIG. 2. It is noted that an IP database used to verify sellers and the IP to-be-sold may take many forms including, but not limited to, a blockchain or other distributed ledger, a peer-to-peer node network (e.g., InterPlanetary File System (IPFS)), a traditional database, a cloud database, the USPTO database, and the like. In this regard, it is noted that the IP database may be duplicated and accessed by each processing node of the CBN as a distributed ledger. Furthermore, it is contemplated that an IP database distributed across the processing nodes of the CBN may allow each IP transaction to be validated by the network of processing nodes. In this regard, it is noted that the present disclosure may provide a more complete and up-to-date listing of the disposition of IP within an IP database.

Those of ordinary skill in the art will recognize that the decentralized structure of a CBN, as depicted in FIG. 2, may facilitate peer-to-peer IP transactions. Furthermore, it is noted that one or more servers may be used to communicatively couple multiple processing nodes (e.g., Seller Computer 1, Buyer Computer 1, Seller Computer 2, and the like) of the cryptographic blockchain network.

In one embodiment, identification information associated with the seller and the IP may be submitted via a user interface of a processing node such that the seller and IP may be registered and stored on the CBN. In another embodiment, the processing nodemay include one or more processors and memory, wherein the one or more processors are configured to execute program instructions stored in memory. In another embodiment, the program instructions may be configured to cause the processor to receive information regarding the patent and other patent identification information through a user interface and submit the information to a decentralized node of a blockchain or distributed ledger (e.g., Ethereum).

In another embodiment, once the seller and the IP have been verified, the IP may be registered on the blockchain network. Registering the IP on the blockchain network may include indexing and referencing the IP such that the IP may be searched and found by potential buyers and others. For example, registering IP on the blockchain network may allow users to search for the IP on the blockchain network using various fields and search functions. For instance, once IP is registered on the blockchain network, potential buyers may be able to search for the IP using keywords and fields including, but not limited to, the type of IP (e.g., patents, trademarks, copyrights), price, field of the IP, name, art unit, inventor, assignee, and the like. It is noted herein that IP registered on the blockchain network may be indexed and searched using any indexing and searching methods known in the art.

In one embodiment, once a seller has verified and registered IP on the blockchain and has decided to sell it, the IP may be incorporated into a “smart contract.” It is noted that the term “smart contract” as it applies to IP transactions in the present disclosure may be referred to as an “IP Contract.”

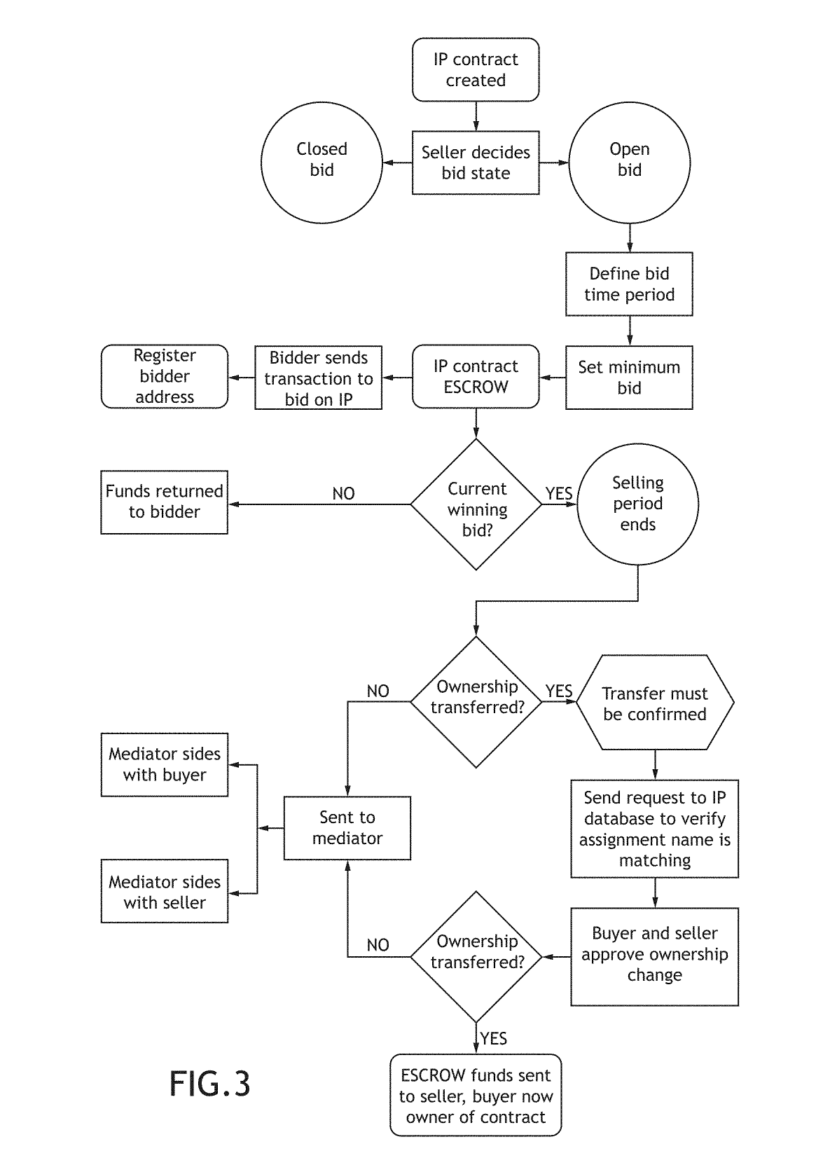

FIG. 3 illustrates a simplified block diagram of an intellectual property smart contract (e.g., IP Contract), in accordance with one or more embodiments of the present disclosure.

In one embodiment, once IP is verified and registered on the blockchain network an IP Contract may be created. The IP Contract may govern how the sale of the underlying IP will take place. For example, an IP Contract may include instructions on how bidding is to take place for the IP, how bids are held in an escrow function, how disputes will be reconciled, and how the IP and bid funds are to trade hands. In one embodiment, a seller may input various transaction parameters which may define instructions on how the IP Contract will govern the transaction. For example, a seller may input transaction parameters including whether the bidding will be “Open” or “Closed,” as shown in FIG. 3. By way of another example, a seller may input other transaction parameters including, but not limited to, minimum bid amount, bidding time period, and the like. These transaction parameters input by the seller will be incorporated into the IP Contract and may govern how the transaction of the underlying IP will be carried out.

In another embodiment, a buyer may register a bidder address on the blockchain in a similar manner to the seller registering the IP to be sold. In order to register a bidder address, a buyer may input identification information via a user interface of a processing node including, but not limited to, the buyer's name, employer, and the like. In this regard, the buyer's name will be the name listed as the new owner of the patent should the buyer complete a patent purchase transaction. For example, a buyer may register a bidder address via a user interface communicatively coupled to a processing node, wherein the processing node includes one or more processors and memory.

Once a buyer has been verified and a bidder address has been registered, the buyer may deposit funds into their bidder address account. It is noted that a funds deposited into a bidder address account may take many different forms. For example, a buyer may simply place US dollars into their bidder address account. By way of another example, a buyer may deposit a form of cryptocurrency into their bidder address account. For instance, buyers may deposit cryptocurrencies including, but not limited to, Ehereum, Bitcoin, Litecoin, and the like.

In another embodiment, buyers may search the CBN for IP to purchase. As noted previously, buyer's may be able to search for IP using any searching function in the art including. For example, buyers may be able to search for IP on the blockchain network using keywords. By way of another example, buyers may be able to search for IP on the CBN by narrowing the search through various search fields including, but not limited to, the type of IP (e.g., patents, trademarks, copyrights), price, field of the IP, name, art unit, inventor, assignee, and the like. In another embodiment, buyers may be able to personalize their bidder address such that the bidder address may provide the buyer with notifications when IP fitting particular buyer-entered criteria is registered on the CBN.

In another embodiment, buyers may submit offers to purchase IP by submitting bids through the blockchain on the relevant IP Contract. It is noted herein that there may be several limitations on the value of a bid a buyer may place. For example, a buyer may be able to place a bid only up to the value of cryptocurrency in their account. By way of another example, where a seller has input a minimum bid value, a buyer may be required to submit bids over the minimum bid value in order for the bid to be recognized on the blockchain. In another embodiment, a buyer may input parameters and/or algorithms to control their bidder address such that their bidder address may automate bids on various IP Contracts according to parameters and/or algorithms. For example, buyers may input algorithms such that their bidder address may automatically place bids on IP Contracts which comply with specific buyer-entered criteria including, but not limited to, the art unit of a patent, field of the IP, type of IP, price range, and the like. In this regard, buyers may personalize their bidder address such that bids may automatically be placed on IP which fits the buyer's criteria.

In another embodiment, once a buyer places a bid, the value of the bid may withdrawn from the funds in the buyer's bidder address account and is placed into the IP Contract's escrow function, as depicted in FIG. 3. In another embodiment, the bid may be held in the escrow function until a transaction resolution event occurs. Transaction resolution events may include, but are not limited to, the seller accepting a bid, a higher bid being placed, a transfer of ownership through assignment, abandonment the transaction, invocation a mediation function, and the like. For example, if a first buyer places a bid on a patent for ten thousand dollars, ten thousand dollars will be withdrawn from the first buyer's bidder address account and held in escrow. Subsequently, a second buyer may place a bid for twelve thousand dollars. This second bid would be identified as a transaction resolution event. In this example, after identification of the transaction resolution event, the IP Contract's escrow function would release the first buyer's funds held in the escrow function back to the first buyer (e.g., credit the first buyer's bidder address account), and withdraw twelve thousand dollars from the second buyer's bidder address account. The twelve thousand dollars withdrawn from the second buyer's bidder address account would then be placed into the escrow function. It is noted that a single IP Contract may encounter any number of transaction resolution events before a sale is completed.

In one embodiment, a seller may actively deny a bid. In this event, the bidder's funds held in the escrow function may be returned to the bidder address account. In another embodiment, a seller may actively accept a bid, thereby triggering a transaction resolution event and closing the bidding time period. In an alternative embodiment, a transaction resolution event may take place when the bidding time period set by the seller expires, as shown in FIG. 3. In this event, the ending of the bidding time period is interpreted as a transaction resolution event.

In another embodiment, a final transaction resolution event may mark the beginning of a sales transaction. Final transaction resolution events may take place when the seller actively accepts a bid or when the bidding time period expires. It is contemplated that other events may be interpreted as final transaction resolution events. In one embodiment, following a final transaction resolution event, a sales transaction for the IP Contract will proceed between the seller and the winning bidder.

In another embodiment, after a final transaction resolution event, the seller may transfer ownership of the IP to the buyer (e.g., the winning bidder). It is noted that a seller may transfer ownership of the underlying IP through by an assignment through an IP database. For example, a seller may transfer ownership of a patent that is the subject of an IP Contract by initiating an assignment on the USPTO database.

In another embodiment, once the seller has transferred ownership to the buyer (e.g., assigned ownership), the transaction must be confirmed. Confirming the transaction may include several steps. For example, confirming the transaction may include sending a request to the USPTO in order to verify the transaction and the bidder's identity.

By way of another example, confirming the transaction may include cross-checking the buyer's name with an IP database (as shown in FIG. 2) to ensure the buyer's name matches the assignment name in the IP Contract. For instance, in order to confirm a transaction for a patent, the IP Contract for the patent may reference the buyer's name as it appears on the bidder address and compare it to the assignments listed in the USPTO. Once the IP Contract finds the assignment of the patent from the seller to the buyer, and confirms that the assignee name matches the name on the bidder address, the IP Contract may confirm the transaction.

By way of another example, confirming the transaction may include both the buyer and seller approving the ownership change and confirming that the title to the patent and the funds in the escrow function will trade hands correctly. It is contemplated that confirming the transaction may include additional steps, and that the examples listed are not to be regarded as required or limiting.

In one embodiment, if the transaction is not confirmed within a specified period of time, the IP Contract may release the funds held in the escrow function back to the buyer. In this regard, the transaction may be considered abandoned. For example, following a final transaction resolution event, the IP Contract for the sale of a patent may provide that the transaction must be confirmed within thirty days. In this example, if the seller fails to assign the patent to the buyer within thirty days, the IP Contract would be unable to find the assignment, and would therefore be unable to confirm the name of the assignee matches the name associated with the bidder address. In this regard, the IP Contract would be unable to confirm the transaction within the thirty day time period, and the transaction would become abandoned. Once the transaction becomes abandoned, the IP Contract may release the funds held in the escrow function back to the buyer. It is noted that, in the event of an abandoned transaction, the parties (e.g., buyer and

In another embodiment, once the transaction has been confirmed, ownership of the IP Contract (and the underlying IP) will be transferred to the buyer and the funds in the escrow function will be released to the seller's account. In this event, the transaction would be considered completed.

In another embodiment, the IP Contract may include a mediation function. In one embodiment, the mediation function may be invoked by either party (e.g., seller, potential buyer, winning bidder, or the like). In one embodiment, the mediation may be conducted by a third party. For example, in the event a party invokes the mediation function, the entire IP transaction history may be sent to an outside third party mediator. The IP transaction history may include, but is not limited to, dates parties registered accounts (e.g., date seller account was registered, date bidder account was registered), date the relevant IP was registered, dates bids were submitted, value of bids, names of the bidders, and the like. Furthermore, in another embodiment, parties may submit supplemental arguments and statements to the mediator. In this regard, the mediation function may allow the third party mediator to reach an equitable solution regarding the IP Contract. In another embodiment, the mediation may be binding, and the mediation outcome may be automatically executed via the mediation function of the IP Contract.

In one embodiment, a party (e.g., seller or bidder) may invoke the mediation function at various points throughout the transaction, as depicted in FIG. 3. For example, a buyer may wish to invoke the mediation function should the seller fail to transfer ownership following a final transaction resolution event. By way of another example, either party may wish to invoke the mediation function if the transaction is not confirmed. It is noted that parties may have the option to invoke the mediation function at various points throughout the IP transaction, and that the examples given are illustrative only and are not to be regarded as limiting.

In another embodiment, once the mediator reaches a solution, the mediation function of the IP Contract may automatically execute the mediation outcome. In this regard, the mediation function of the IP Contract may be configured to carry out a number of actions in order to implement the mediation outcome including, but not limited to, transferring ownership of the IP Contract (and the underlying IP), releasing funds held in the escrow function to the seller, refunding the funds held in the escrow function to the buyer, and the like.

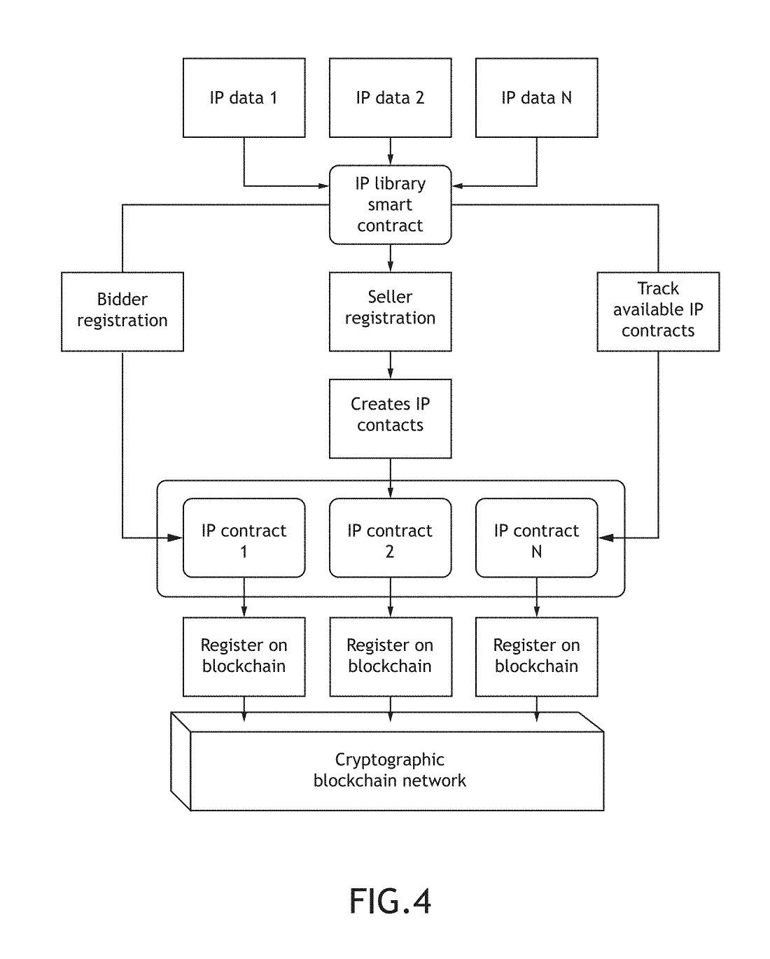

FIG. 4 illustrates a simplified block diagram of an intellectual property smart contract library, in accordance with one or more embodiments of the present disclosure.

In another embodiment, multiple IP Contracts relating to a single patent, trademark, or copyright may be registered on the blockchain and arranged in an IP Library Smart Contract, as shown in FIG. 4.

As noted previously herein, a seller may input IP Data regarding the IP to be sold into an IP Library Smart Contract. IP Data may include any information and data which may be used to identify, link, and describe the IP to be sold. For example, as depicted in FIG. 4, a seller may input IP Data 1, IP Data 2, and IP Data N into the IP Library Smart Contract via a user interface of a processing node. IP Data may include any identification data associated with the IP including, but not limited to, application number, serial number, inventor, filing date, and the like.

In another embodiment, after a seller has input IP Data, the seller may be registered on the CBN. Similar to before, a seller may be registered on the CBN such that potential buyers may be assured that the seller is able to transfer title to the IP. In one embodiment, in order to become registered with the IP on the blockchain, the seller may input personal identification information via a user interface of a processing node. For example, a seller may input personal identification information including, but not limited to, name, employer, relationship to the IP (e.g., inventor, owner, assignee, licensee, and the like), and the like. As stated previously, a seller may be verified through an identify management system and/or by reference to an IP database. For example, the IP Library Smart Contract may confirm the seller's identity through an identity management system including, but not limited to, uPort, Keybase, and the like. In another embodiment, once the seller has input personal identification information and has been verified, they become registered on the CBN and are associated with the IP Library Smart Contract.

In another embodiment, the IP Library Smart Contract may create multiple IP Contracts associated with the single IP item to be sold. For instance, as shown in FIG. 4, the IP Library Smart Contract may create a first IP Contract (e.g., IP Contract 1), a second IP Contract (e.g., IP Contract 2), and an N^{th} IP Contract (e.g., IP Contract N). It is noted herein that the creation of multiple IP Contracts may allow a seller to tailor the various IP Contacts in order to fit the needs of a wider range of potential buyers. It is noted herein that the various IP Contracts created by the IP Library Smart Contract may vary in many different aspects including, but not limited to, geographic scope, license rights, assignment rights, price, and the like.

In another embodiment, each IP Contract created by the IP Library Smart Contract may be registered on the blockchain. In another embodiment, the IP Contracts may be indexed and searched through the cryptographic blockchain network.

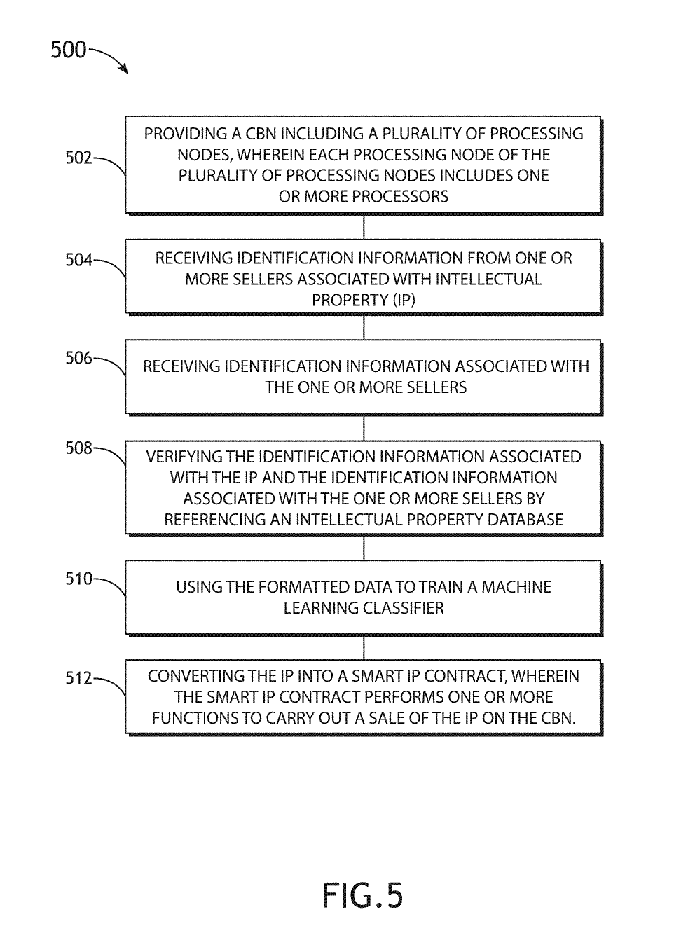

FIG. 5 illustrates a flowchart of a method 500 for peer-to-peer electronic exchange of intellectual property ownership, in accordance with one or more embodiments of the present disclosure.

In a step 502, a CBN including a plurality of processing nodes, wherein each processing node of the plurality of processing nodes includes one or more processors is provided.

In a step 504, identification information associated with the intellectual property (IP) is received from one or more sellers.

In a step 506, identification information associated with the one or more sellers is received.

In a step 508, the identification information associated with the IP and the identification information associated with the one or more sellers is verified by referencing an intellectual property database

In a step 510, the IP is converted into a Smart IP Contract, wherein the Smart IP Contract performs one or more functions to carry out a sale of the IP on the CBN.

In one embodiment, the one or more processors of the processing nodes may include any one or more processing elements known in the art. In this sense, the one or more processors may include any microprocessor-type device configured to execute software algorithms and/or instructions. In one embodiment, the one or more processors may consist of a server, desktop computer, mainframe computer system, workstation, image computer, parallel processor, or other computer system (e.g., networked computer) configured to execute a program configured to operate the system, as described throughout the present disclosure. It should be recognized that the steps described throughout the present disclosure may be carried out by a single computer system or, alternatively, multiple computer systems. In general, the term “processor” may be broadly defined to encompass any device having one or more processing elements, which execute program instructions from memory. Moreover, different subsystems of the system may include processor or logic elements suitable for carrying out at least a portion of the steps described throughout the present disclosure. Therefore, the above description should not be interpreted as a limitation on the present disclosure but merely an illustration.

The memory of the processing nodes may include any storage medium known in the art suitable for storing program instructions executable by the associated one or more processors and the data received from a user. For example, the memory may include a non-transitory memory medium. For instance, the memory may include, but is not limited to, a read-only memory, a random access memory, a magnetic or optical memory device (e.g., disk), a magnetic tape, a solid state drive and the like.

In another embodiment, the processing node may be communicatively coupled to a user interface. In another embodiment, a user may input IP information (e.g., information relating to the patent) and personal identification information (e.g., seller, assignor, and the like) via the user interface.

In one embodiment, the user interface includes a display used to display data of the system to a user. The display of the user interface may include any display known in the art. For example, the display may include, but is not limited to, a liquid crystal display (LCD), an organic light-emitting diode (OLED) based display, or a CRT display. Those skilled in the art should recognize that any display device capable of integration with a user interface is suitable for implementation in the present disclosure. In another embodiment, a user may user may input selections and/or instructions responsive to data displayed to the user via the user interface.

### EXAMPLE

The first function is to simplify and automate the transactions of patents between buyers and sellers. A patent owner/seller/assignor can access the user interface and submit a patent for sale by entering patent identification and assignor identification information. Once submitted, the patent is turned into a smart contract referred to as a IP Contract. This IP Contract initiates the requirements of a seller including minimum bids, open/closed for bidding, and accept/deny bids.

As a potential buyer of a patent, the buyer/assignee must first register through the user interface either by an address or identity management system.

This registration requires the name(s) of the assignee that the patent assignment will update to under the new ownership. Once registered, the buyer is able to bid on available patents.

If the buyer's bid is accepted by the seller, the bid amount is placed into the IP Contract's escrow function. The escrow function holds the buyer's bid amount until a transaction resolution event. These events include replacement by better bid, transfer of ownership through assignment change, abandoned transactions, and mediation resolutions.

When a better bid comes in, the escrow function releases funds back to the losing bidder.

Transfer of ownership through assignment change is done by the seller through an intellectual property database (USPTO). As required by the USPTO in a patent assignment change, the seller does the proper legal work in a defined period of time. In Kyna's system, the USPTO is the trusted authority on patent assignments. During the escrow period, the IP Contract is checking the IP database through an oracle for matching assignment data between the IP database and the buyer's name. Once matching, the IP Contract releases the bid amount from escrow to the seller and the buyer is the new owner of the patent.

When assignments aren't updated in the specified period of time, the IP Contract releases the bid amount back to the buyer and is considered an abandoned transaction. Buyer and seller would have to create a new IP Contract to proceed.

If any problems arise during the transaction, the IP Contract has a mediation feature that either parties can invoke.

Sellers

An IP owner/seller submits patent or trademark by entering IP identification and assignor identification. IP identification and assignor identification is submitted through a user interface on a computer device.

The computer device runs a decentralized node of a blockchain or distributed ledger such as Ethereum.

The computer device may connect to an externally owned account such as MetaMask to connect to a node.

Intellectual Property Identification:

Patent identification can be application number.

Patent identification can be patent number.

Patent identification can be publication number.

Patent identification can be international registration number.

Patent identification can be PCT number.

Patent identification can be reel/frame number.

Patent identification can be any other verifiable identification of patent.

Trademark identification can be reel/frame number.

Trademark identification can be serial number.

Trademark identification can be registration number.

Trademark identification can be international registration number.

Trademark identification can be any other verifiable identification of trademark.

Owner/Seller/Assignor identification is the assignor's name.

Verification of the IP and assignor by pulling IP information from intellectual property database.

Verification of the IP and assignor through an identity management system.

The IP is turned into a smart contract hereby referred to as an IP contract.

Buyers

A buyer registers their address through a user interface on a computer device.

The computer device may run a decentralized node of a blockchain or distributed ledger such as Ethereum.

The computer device may connect to an externally owned account such as MetaMask to connect to a node.

A buyer address may register through an identity management system.

A buyer address may place a bid on IP through the user interface.

A buyer address may automate a bid on IP based on requirements created by internal user metrics algorithms.

IP Contract

The IP Contract is a smart contract that handles bidding, escrow, and dispute functions around the exchange of IP between parties. It's process is detailed in FIG. 3.

The IP Contract can be open or closed as determined by seller.

The IP Contract can accept or deny bids as determined by seller.

The IP Contract can have a minimum bid and bid time period as determined by the seller.

A process where a bid pulls the bid amount out of the buyer's address into the IP contract's escrow function until transaction completion or better competing bid.

Transaction completion can be transfer of ownership through assignment update, abandoned transaction, mediation decision, etc. After transaction completion, bid amount is released to the correct address determined by the transaction completion outcome.

A process where a buyer places a bid, the bid amount is held in the IP contract's escrow function until transaction completion or better competing bid.

A process where if the owner/seller address accepts the bid, the bid amount is held in the IP contract's escrow function until transaction completion or better competing bid. The bid amount is held in escrow until the owner/seller/assignor properly updates the assignment of the IP through the IP database to the buyer/assignee or other previously stated transaction outcomes i.e. abandoned transaction, mediation, etc.

IP database can be a blockchain or a distributed ledger

IP database can be a peer-to-peer node network like IPFS

IP database can be a traditional database or cloud database

Once the assignment is updated in the IP database, buyer and seller must agree that it was properly updated.

The bid amount is released from the IP contract escrow to the original owner/seller/assignor.

If they don't agree, the two parties enter mediation. Mediation is handled by a third-party who decides outcome.

IP Library Smart Contract

The IP Library Smart Contract is a unique script that deploys IP Contracts to the blockchain and tracks the available IP Contracts on the blockchain. This process is illustrated in FIG. 4.

The process starts with IP Data from sellers being fed to the IP Library Smart Contract (IP Data 1, IP Data 2, IP Data N). IP Data includes IP ID and any other data to identify, link, and describe the IP.

The IP Library Smart Contract confirms the seller through assignor id or an identity management system such as uPort or keybase.

The IP Library Smart Contract then creates IP Contracts based on the IP Data provided. The IP Library Smart Contract registers the bidder through assignee id or an identity management system such as uPort or keybase. The IP Contracts are registered on the cryptographic blockchain network.

Additional Discussion

Kyna is a tokenized patent protocol that will increase the liquidity of innovation in our global economy. As organizations, both centralized and decentralized, become more connected and collaborative, it will be imperative that the availability of patents are increasingly liquid. Essentially, Kyna is a decentralized ecosystem of organizations and inventors that want to efficiently manage and trade patent rights.

Kyna users will exchange standardized patent contracts utilizing Solidity smart contracts and a web-based dApp.

This paper will first address problems with the patent system and how it is a barrier to global innovation. The paper will then detail how Kyna will build a decentralized patent exchange for buyers, sellers, and licensors of patents. Finally, the system and method for tokenizing the patent ecosystem will be explained.

1. Introduction

Kyna is a protocol that creates a blockchain patent exchange for buyers, sellers, and licensors of patents on the Ethereum blockchain protocol.

Kyna implements a blockchain patent exchange to buy, sell, and license patents. This is done through automated assignment changes, the standardization of contracts, and automated arbitration.

2. The Troubled Patent Ecosystem

A. Patents

A patent for an invention is the grant of a property right to the inventor with the right to exclude others from making, using, offering for sale, selling or importing the invention to promote progress within society. “ . . . Patent laws promote this progress by offering a right of exclusion for a limited period as an incentive to inventors to risk the often enormous costs in terms of time, research, and development.”

Patent rights are and have been granted from the understanding that “to grant patents . . . is the conviction that encouragement of individual effort by personal gain is the best way to advance public welfare through the talents of . . . inventors in ‘Science and useful Arts.’ Sacrificial days devoted to such creative activities deserve rewards commensurate with the services rendered.

Necessarily, patents exist to protect inventor's inventions from being “exploited” by others while still disclosing what the invention is to the public to advance innovation within economies.

It is sometimes helpful to think of a patent as a tangible asset, though not a perfect analogy. Individuals who own a tangible asset, such as a car, wouldn't want another individual who doesn't own the car to have the ability to use or sell it without proper remuneration. The property rights granted to inventors through patents allow them to exclude others from selling their invention. Fundamentally, this makes sense. However, because inventions and the patents behind them tend to be intangible and hard to comprehend, it is difficult for people to agree that someone has the right to exclude others from an invention. These disagreements are especially prominent within the open-source culture of the software industry. In fact, many believe that software shouldn't even be patentable because of conceptual ambiguity.

B. Patent Market

The patent market is a relatively recent development with patent “brokers” developing in the early 2000s. Before this time, patents were considered to be something that weren't exchangeable between entities. Fast forward a decade and you can see the patent market has matured with the advances from Ocean Tomo, a patent transaction financing firm and the innovative, yet failed, IPXI, an exchange focused on patent licenses.

Moving to the present day, it is apparent that the patent market is a real and growing market. However, it is clear that the marketplace has hit the upper bounds of its success without an advancement in innovation and a further culture change. As it stands now, there are three major problems that need to be solved before a true patent marketplace can exist.

First, is the liquidity problem. Only 5% of patents are considered to be “liquid” and only 14% of patents put up for sale are sold after 12 months. This liquidity problem requires entities to dedicate massive resources to find and source buyers and sellers. There is also the problem that “liquidity premiums”, in other markets, exist when valuing liquid assets vs. illiquid assets. This leads to the second major problem, valuation.

Proper valuation of patents is extremely difficult with only 3% of patents being properly valued. “Value does not exist in the abstract and must be addressed within the context of time, place, potential owners, and potential uses”. Additionally, research has found that there is a $3.2 million standard deviation in patent value. To an extent, the liquidity problem and the valuation problem are a chicken or the egg problem. Liquidity is low because it's hard for parties to agree on value; valuations are bad because there isn't enough liquidity to provide proper data. Market, Income, and Cost valuation methods are the standard in the industry today. However, these are intense and expensive valuation methods that can limit the ability of buyers and sellers to enter the market if they don't carry the necessary economies of scale.

Finally, the patent market must overcome its asymmetrical and esoteric data problem. Data in the marketplace is held by patent attorneys, patent strategists, patent brokers, and others entrenched in the patent system. This asymmetry is the product of the costs associated with the lack of liquidity and the lack of proper valuation but also the deep knowledge required in patent law to operate successfully. This asymmetrical data significantly helps the market makers of patents while hindering the sellers of patents.

C. Litigation

Litigation around patents mostly comes in two forms. First, there is litigation from practicing entities, such as Apple suing Google for patent infringement. This company vs company litigation is reaching numbers in excess of $2.5 Billion.

Then, there is litigation from non-practicing entities (NPEs). NPEs are entities that hold patents but do not commercialize their patents and instead monetize through litigation and licensing. Or, more exactly, licensing through litigation. NPEs are referred to as “patent trolls” in the media and are blamed for corrupting the patent system as a whole. NPEs attributed to $29 Billion in direct costs of litigation in 2011. It should be noted that only 0.89% of patents are litigated against. Couple these previous two statistics with the fact that an estimated $1 trillion worth of IP goes underutilized by US companies and it can be questioned why corporations and media spend so much time worried about patent trolls.

The more important question that needs to be asked around NPEs is why are they a profitable business model and where are the patents coming from? After all, NPEs, barring Intellectual Ventures, aren't an invention factory developing their own patents. Instead, NPEs acquire patents from individual inventors, startups, distressed companies, etc. This lends to the idea that NPEs may exist simply as an intermediary in the patent marketplace to help sellers of patents monetize their portfolio. They really serve as an imperfect solution for sellers of patents to solve the liquidity, valuation, and asymmetrical problems alluded to earlier in the Patent Market section.

3. Blockchain Patent Exchange

A. Automated Patent Transactions

The blockchain patent exchange (BPX) mechanism is the foundation and center-piece for creating a patent protocol where buyers and sellers can exchange their patents. It will allow for efficiencies both in today's patent world and significant advancements in a future patent world defined by decentralization and tokens. The BPX's first function is to simplify and automate the transactions of patents between buyers and sellers. With BPX, a patent owner/seller/assignor can access the BPX user interface and submit a patent for sale by entering patent identification and assignor identification information. Once submitted, the patent is turned into a smart contract referred to as an IP Contract. This IP Contract enacts the requirements of a seller including minimum bids, open/closed for bidding, and accept/deny bids.

As a potential buyer of a patent, the buyer/assignee must first register through the BPX user interface either by an address or identity management system such as uPort. This registration requires the name(s) of the assignee that the patent assignment will update to under the new ownership. Once registered, the buyer is able to bid on available patents.

If the buyer's bid is accepted by the seller, the bid amount is placed into the IP Contract's escrow function. The escrow function holds the buyer's bid amount until a transaction resolution event. These events include transfer of ownership through assignment change, abandoned transactions, and mediation resolutions.

B. Assignment Change

Transfer of ownership through assignment change is done by the seller through the USPTO. As required by the USPTO in a patent assignment change, the seller does the proper legal work in a defined period of time. In Kyna's system, the USPTO is the trusted authority on patent assignments. During the escrow period, the IP Contract is checking the USPTO database through an oracle for matching assignment data between the USPTO and the buyer's name. Once matching, the IP Contract releases the bid amount from escrow to the seller and the buyer is the new owner of the patent.

When assignments aren't updated in the specified period of time, the IP Contract releases the bid amount back to the buyer and is considered an abandoned transaction. Buyer and seller would have to create a new IP Contract to proceed.

C. Mediation

If any problems arise during the transaction, the IP Contract has a mediation feature that either parties can invoke. Mediation is handled for a 35% fee by Kyna through traditional non-blockchain mediation methods. This 35% fee was chosen as it mimics the traditional fee structure held by brokers in the space.

D. Prototype

The current process described above is a working prototype built on the Ethereum Ropsten Test Network. It has not been deployed on the main network because it still needs to go through security audits and bug bounties.

4. Patent Protocol

Patent exchanges are not a new development in the patent world. Nor do they solve the problems of valuation, liquidity or asymmetrical data mentioned early in the paper. In fact, many have tried a marketplace and many have failed because of the complexities involved. However, tokenization and smart contracts provide a new tool to solve many of the problems afflicting the deficiencies of prior attempts. Kyna's next step will be creating a tokenized patent protocol and ecosystem to incentivize all players in the market to coordinate together to solve these problems. The protocol consists of a token, patent address, and library.

A. Token

Kyna's token will be a token sale Ethereum ERC20 token that incentivizes patent owners, brokers, valuators, strategists, and buyers to coordinate the buying, selling, and licensing of patents. This token is a usage token that allows parties within the protocol to value and garner services within the ecosystem. These tokens have three purposes.

The first purpose is to facilitate an exchange of a patent assignment or licensing agreement. Patents' value will be represented with these tokens. To buy a patent, you will have to first buy Kyna tokens and then use the tokens to bid on the patent.

The second purpose is to build patent pools. Patent pools are groupings of patents with the purpose to increase the valuation and/or bargaining power of patents and provide defensive litigation protection, collectively. The adage that there is “power in numbers” is true with patents. This pooling function is what will provide individual inventors and startups the ability to leverage against the big players in the market and level the playing field. This will be the function that “decentralizes” the patent marketplace by providing centralized power to individual patents. This function is similar to how both the RPX Corporation and Allied Security Trust operate as defensive litigation firms. However, instead of just providing defensive litigation, it serves to properly value patents and protect individual patents.

The final purpose of the token is to pay for third-party patent services including patent lawyers, strategists, and brokers. Valuations of patents are stronger and less ambiguous when more information is known and clearly defined about the patent. This is the asymmetrical and esoteric data problem mentioned in the Patent Market section. Stronger valuations start with the writing of the patent, wholesale prior art searches, disclosures of encumbrances, and clearly defined sales and licensing terms.

Third-party services can be paid for in two ways. The first is as a percentage of the sale of a patent. A buyer and/or seller can offer a percentage of the sale to incentivize a third-party to provide a service. The second method is as a bounty. Bounties are paid before the sale and will function well to discover unknown data important to the valuation of a patent and incentivize the disclosures of encumbrances. This third purpose of the token is designed to properly align and incentivize all players in the market to act rationally and in the best interest of the patent ecosystem as a whole, not just as an individual.

B. Patent Address

The patent address holds the patent information such as patent number, inventors, encumbrances, and any other attributes relevant to a sale. These attributes can be disclosed by buyer, seller, and third-party services mentioned in the Token section. Furthermore, the patent address will hold the escrow function previously explained in the blockchain patent exchange. This will allow the patent address to hold the token value of the patent as it goes through assignment changes and any other transactions around the patent.

C. Library

The library creates the ID of each patent and maps it across the blockchain. This makes a patent tradable and trackable through its lifetime. The library can also hold and track licensing rights that are attached to the patent. This library enables the protocol to handle buying, selling, pooling, and licensing of patents.

All of the methods described herein may include storing results of one or more steps of the method embodiments in memory. The results may include any of the results described herein and may be stored in any manner known in the art. The memory may include any memory described herein or any other suitable storage medium known in the art. After the results have been stored, the results can be accessed in the memory and used by any of the method or system embodiments described herein, formatted for display to a user, used by another software module, method, or system, and the like Furthermore, the results may be stored “permanently,” “semi-permanently,” temporarily, or for some period of time. For example, the memory may be random access memory (RAM), and the results may not necessarily persist indefinitely in the memory.

It is further contemplated that each of the embodiments of the method described above may include any other step(s) of any other method(s) described herein. In addition, each of the embodiments of the method described above may be performed by any of the systems described herein.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mateable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A system comprising:
a cryptographic blockchain network (CBN) including a plurality of processing nodes, wherein one or more processing nodes of the plurality of processing nodes includes one or more processors configured to:
receive identification information from one or more sellers associated with intellectual property (IP);
receive identification information associated with the one or more sellers;
verify the identification information associated with the IP and the identification information associated with the one or more sellers by referencing an intellectual property database;
convert the IP into a Smart IP Contract, wherein the Smart IP Contract performs one or more functions to carry out a sale of the IP on the CBN.

2. The system of claim 1, wherein the one or more functions to carry out the sale of the IP on the CBN include:
receiving bids from one or more bidder addresses;
holding bids in an escrow function;
identifying a final transaction resolution event and a winning bidder;
transferring bids held in the escrow function to the seller; and
transferring ownership of the Smart IP Contract to the winning bidder.

3. A method comprising:
providing a cryptographic blockchain network (CBN) including a plurality of processing nodes, wherein each processing node of the plurality of processing nodes includes one or more processors;
receiving identification information from one or more sellers associated with intellectual property (IP) to be sold on the CBN;
receiving identification information associated with the one or more sellers;
verifying the identification information associated with the IP and the identification information associated with the one or more sellers by referencing an intellectual property database;
converting the IP into a Smart IP Contract, wherein the Smart IP Contract is configured to carry out one or more steps to carry out a sale of the IP on the CBN.

4. The method of claim 3, wherein the one or more steps to carry out the sale of the IP on the CBN include:
receiving bids from one or more bidder addresses;
holding bids in an escrow function;
identifying a final transaction resolution event and a winning bidder;
transferring bids held in the escrow function to the seller; and
transferring ownership of the Smart IP Contract to the winning bidder.
